(19) United States
(12) Patent Application Publication
(10) Pub. No.: US 2024/0185110 A1
(43) Pub. Date: Jun. 6, 2024

(54) DISTRIBUTION OF QUANTUM STATE VECTOR ELEMENTS ACROSS NETWORK DEVICES IN QUANTUM COMPUTING SIMULATION

(71) Applicant: NVIDIA Corporation, Santa Clara, CA (US)

(72) Inventor: Shinya MORINO, Tokyo (JP)

(73) Assignee: NVIDIA Corporation, Santa Clara, CA (US)

(21) Appl. No.: 18/526,829

(22) Filed: Dec. 1, 2023

Related U.S. Application Data
(60) Provisional application No. 63/429,286, filed on Dec. 1, 2022.

(51) Int. Cl. G06N 10/20; G06N 10/40

(52) U.S. Cl. CPC G06N 10/20; G06N 10/40

(57) ABSTRACT

Aspects of this technical solution can identify, based at least on a representation of a quantum computing circuit, a first node of a topology of a computing platform configured to simulate at least a portion of the quantum computing circuit, compute a first metric indicating a first latency including the first node, the first latency based at least on a portion of the topology including the first node, select a second node of the topology having a second metric indicating a second latency less than the first latency, the second latency based at least on a portion of the topology including the second node, and simulate the quantum computing circuit on the computing platform using the second node.

### TECHNICAL FIELD

The present implementations relate generally to computer networks, including but not limited to distribution of quantum state vector elements across network devices in quantum computing simulation.

### INTRODUCTION

Computing platforms are increasingly expected to perform more complex tasks at higher speed and with reduced computational resource expenditure. Many high complexity tasks can potentially be executed effectively via quantum computation. However, the quantum hardware as of today is unstable to solve problems as expected. In order to develop quantum computing hardware, quantum computing simulations based on classical hardware has become an increasingly important need. Unfortunately, classical computing environments configured to perform computation corresponding to quantum computation are highly computing-power intensive, and unsuitable to perform the necessary computations effectively. Moreover, lack of management of high resource utilization at large scales in conventional systems thus results in degradation of performance of quantum circuit simulation on classical computing platforms.

### SUMMARY

The present disclosure includes one or more technical solutions directed at least to accelerating the simulation of quantum circuits represented by state vectors comprised of multiple qubits by segmenting the state vectors to discrete portions, and allocating (e.g., assigning) those portions among a plurality of processing nodes (e.g., computing devices/environments). In this way, a larger quantum circuit (represented by a larger state vector) can be simulated over multiple processing nodes than would be possible to simulate in a single node. In one or more embodiments of the present disclosure, simulating a quantum circuit may be accelerated by determining an allocation (e.g., assignment) of state vector portions (e.g., qubits) to processing nodes that is optimized for the particular network topology of the processing nodes. The allocation may be optimized by recursively reordering portions of a quantum circuit with respect to one or more levels of a multi-level hierarchical network architecture during simulation. For example, a system can identify a computationally intensive period of simulation of a quantum circuit that is allocated to nodes within the same network separated by network switches at a higher level of the network hierarchy. The system can reallocate simulation of portions of the quantum circuit to nodes separated by fewer or no switches at a lower level of the network hierarchy. For example, the system can identify particular qubits corresponding to particular levels of a network hierarchy, and can (e.g., recursively) reorder a portion of the qubits in computing devices bounded by particular timestamps to a different layer of the network hierarchy. In one or more embodiments, reordering is performed recursively (e.g., during simulation) until an allocation is achieved that maximizes the transfer of data between nodes of the lowest level in a network topology and/or within the same cluster, and minimizes the transfer of data between nodes of different clusters and/or network layers. Thus, the technical solution can include optimized simulation of quantum circuits by allocation of portions of a simulated quantum circuit within a network of computing nodes based on a distance between nodes as defined by the network hierarchy connecting the nodes. In other words, in one or more embodiments, qubits are reordered and distributed among and between nodes based on the how the qubits are connected to other qubits in the same quantum circuit. Thus, a technical solution for allocation of quantum state vector components across network devices in quantum computing simulation is provided.

At least one aspect is directed to a processor that can include one or more circuits. The processor can identify, based at least on a representation of a quantum computing circuit, a first node of a network of a computing platform configured to simulate at least a portion of the quantum computing circuit. The processor can compute a first value according to a latency metric, the first value indicating a first latency (e.g., of communication latency/bandwidth) of a first distribution of qubits between multiple nodes. The first latency can be based at least on simulating a quantum circuit that can include transferring qubit data between nodes according to the first distribution. The processor can select a second distribution of the qubits that achieves a second value according to the latency metric, the second value indicating a second latency less than the first latency. The second latency can be based at least on a re-ordering of the qubits distributed among multiple nodes of a network based on network topology. The processor can simulate the quantum computing circuit on the computing platform using the second distribution.

At least one aspect is directed to a method. The method can include identifying, based at least on a representation of a quantum computing circuit, a first node of a network topology of a computing platform configured to simulate at least a portion of the quantum computing circuit. The method can include computing a first value according to a latency metric, the first value indicating a first latency that can include the first node. The first latency can be based at least on a portion of the topology that can include the first node. The method can include selecting a second node of the topology having a second metric indicating a second latency less than the first latency. The second latency can be based at least on a portion of the topology that can include the second node. The method can include simulating the quantum computing circuit on the computing platform using the second node.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example network architecture, in accordance with present implementations.

FIG. 2 depicts an example quantum circuit architecture, in accordance with present implementations.

FIG. 3 depicts an example network architecture, in accordance with present implementations.

FIG. 4 depicts an example quantum state vector architecture, in accordance with present implementations.

FIG. 5A depicts an example local quantum state vector swap operation, in accordance with present implementations.

FIG. 5B depicts an example first level quantum state vector swap operation, in accordance with present implementations.

FIG. 6 depicts an example global quantum state vector swap operation, in accordance with present implementations.

FIG. 7A depicts an example diagram of an identification of a swap for a quantum circuit across network levels, in accordance with present implementations.

FIG. 7B depicts an example diagram of a swap operation for a quantum circuit across network levels, in accordance with present implementations.

FIG. 8 depicts an example method of gate group selection, in accordance with present implementations.

FIG. 9A depicts an example diagram of a selection of a two-qubit gate group, in accordance with present implementations.

FIG. 9B depicts an example diagram of a selection of a three-qubit gate group, in accordance with present implementations.

FIG. 9C depicts an example diagram of blocking of a gate group, in accordance with present implementations.

FIG. 10A depicts an example diagram of gate groups of a quantum circuit, in accordance with present implementations.

FIG. 10B depicts an example diagram of sorted gate groups of a quantum circuit, in accordance with present implementations.

FIG. 11 depicts an example quantum circuit with gate groupings based on group size thresholds, in accordance with present implementations.

FIG. 12 depicts an example quantum circuit simulation architecture, in accordance with present implementations.

FIG. 13 depicts an example quantum state vector allocation architecture, in accordance with present implementations.

FIG. 14 depicts an example method of allocation of quantum state vector components across network devices in quantum computing simulation, in accordance with present implementations.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

This disclosure relates to systems and methods for simulation of quantum circuits by hierarchical allocation across network levels. A quantum circuit simulation can include a plurality of simulated quantum bits (“qubits”) and one or more quantum gates linked with various qubits. Each qubit can have a particular quantum state indicating a probability of having a binary state of 1 or 0 upon measurement of the qubit. Various quantum gates can perform operations on one or more qubits, to modify the probability of having the binary state of 1 or 0 upon measurement of the qubit. The simulation can include controlled quantum gates whose operations are dependent on a particular state of one or more qubits with which the controlled quantum gates are linked. A digital computing system can allocate substantial computing resources to simulate numerous quantum interactions in accordance with a network architecture having one or more nodes. Each node can correspond to a physical machine or virtual machine having an architecture compatible with generating, maintaining, and modifying one or more quantum states. The network, via one or more of the nodes (e.g., computing devices), can represent the one or more state of a quantum circuit as one or more (e.g., one) corresponding state vector(s). The state vector may be represented or implemented using a complex number, and which can indicate a probability having the binary state of 1 or 0 upon measurement, of one or more qubits, quantum gates, or any combination thereof.

A network architecture configured to simulate a quantum circuit can include one or more network switches connecting various nodes in a multi-level hierarchical architecture. For example, a plurality of nodes can be connected with corresponding switches to form a plurality of clusters at a lowest level of a hierarchy of layers of a network. Each cluster can be connected with additional switches to form a plurality of clusters at a higher level of the network hierarchy. Additional layers of the network hierarchy can be added by linking clusters of nodes by their highest-level switches by one or more additional switches. A single switch connected with all switches of a lower level can correspond to a highest-level switch. In a network architecture, latency can be lowest for communication within a node, lower for communication between nodes through a single switch layer, and higher as communication travels through multiple switch layers between nodes of different clusters. For example, the data transfer latency is lowest between devices within a node. Thus, this technical solution can provide at least the technical improvement of reducing latency of simulation of quantum circuits by, for example, allocating portions (e.g., wires) of a quantum circuit to particular nodes within the same network layer based on their proximity to each other in the network hierarchy and the complexity of the portion of the quantum circuit to be simulated.

For example, this technical solution can include at least a technical improvement to accelerate quantum circuit simulations via re-ordering the processing of portions of a state vector to multiple nodes at the start of simulation. A quantum circuit simulation can operate via a “state vector” including a vector with complex numbers to collectively represent a quantum state of the qubits in the quantum circuit. The size of the state vector can increase exponentially as the number of qubits increases in a quantum circuit. When the size of a state vector is too large to be placed in a single device, the state vector can be simulated by distributing separate portions of the state vector for simulation in multiple devices by using the memory of the multiple devices to store the data required to perform the simulations. However, once distributed, data transfers may be required between devices during simulations. As inter-cluster/inter network layer data transfer is slower than memory accesses within a device or within devices in the same cluster, the scaling of the simulation performance can be slowed and quantum computing computations can also be slowed. To provide a technical improvement to increase computational bandwidth, portions of a simulated quantum circuit coupled with particular simulated qubits can be reordered with respect to particular layers of a network hierarchy to improve latency of a network topology to reduce data transfer latency.

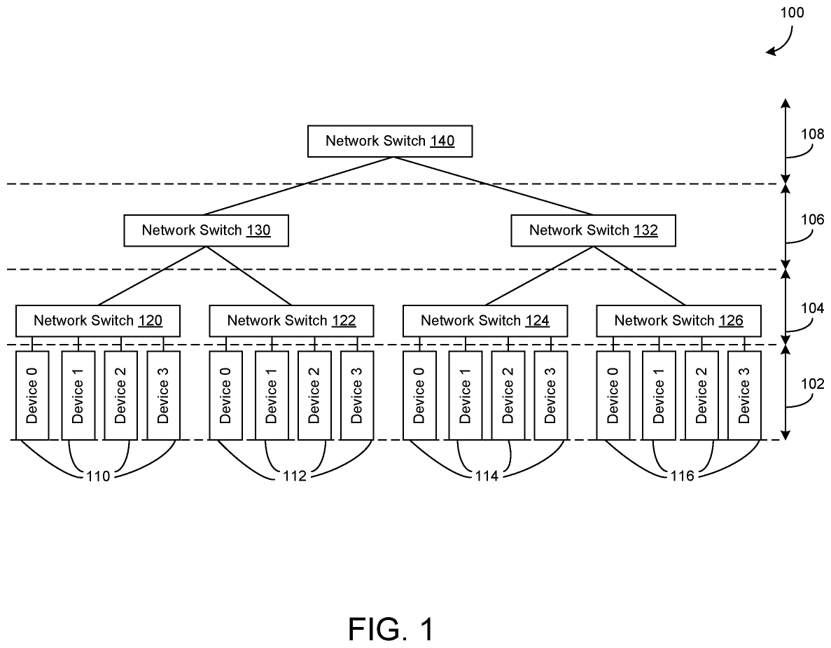

FIG. 1 depicts an example network architecture, in accordance with present implementations. As illustrated by way of example in FIG. 1, an example network architecture 100 can include at least a device layer 102, a lower network layer 104, a higher network layer 106, and a root network layer 108. The network architecture 100 can include a hierarchical multi-level network structure to mitigate performance limitations arising from data transfers. By taking advantage of the multi-level structure, this technical solution can include a technical improvement of performance limitations arising from data transfers that can be mitigated by proactively utilizing a faster data communication link in lower levels and reducing the usage of slower data communication links.

The device layer 102 can correspond to a lowest layer of the network architecture 100, below a lower network layer 104. For example, the device layer 102 can correspond to an endpoint of a network, board-level integration, or any combination thereof. The device layer 102 can include one or more sets of devices 110, 112, 114, and 116. The lower network layer 104 can correspond to a gateway layer of the network architecture 100. For example, the lower network layer 104 can correspond to a local network or network coupling at a rack level. The lower network layer 104 can include a network switch 120, a network switch 122, a network switch 124, and a network switch 126. The higher network layer 106 can correspond to a third or intermediate layer of the network architecture 100. For example, the higher network layer 106 can correspond to a wide area network or a network coupling at a server array level. The higher network layer 106 can include a network switch 130 and a network switch 132. Although not illustrated, the network architecture 100 can include one or more intermediary network layers between the lower network layer 104 and the higher network layer 106 and the concepts and explanation provided herein can apply to such intermediary network layers. The root network layer 108 can correspond to a highest layer of the network architecture 100. For example, the root network layer 108 can correspond to an Internet server or backbone, or a network coupling at a datacenter level. The root network layer 108 can include a network switch 140.

The devices 110 can correspond to a first discrete portion of the device layer 102 having a minimum latency or range of latencies with respect to communication within devices 110, 112, 114 and 166. For example, the devices 110 can have a lowest latency in the network architecture 100, corresponding to a communication bandwidth within a local device or processor, for example, that exceeds a communication bandwidth over a network communication channel. The devices 110 can correspond, for example, to processors coupled with a local communication channel having a latency lower than a network communication channel. For example, a local communication channel can include, but is not limited to, a communication bus of a motherboard. The devices 112 can correspond at least partially in one or more of structure and operation to the devices 100, and can correspond to a second discrete portion of the device layer 102 distinct from the first discrete portion of the device layer 102. The devices 114 can correspond at least partially in one or more of structure and operation to the devices 100, and can correspond to a third discrete portion of the device layer 102 distinct from the first and second discrete portions of the device layer 102. The devices 116 can correspond at least partially in one or more of structure and operation to the devices 100, and can correspond to a fourth discrete portion of the device layer 102 distinct from the first, second and third discrete portions of the device layer 102. This technical solution is not limited to the number or type of devices 110, 112, 114 and 116 depicted by way of example in the network architecture 100. The devices 110, 112, 114 and 116 are not limited to a same latency or bandwidth.

The network switch 120 can correspond to a first discrete portion of the lower network layer 104 having a latency or range of latencies with respect to communication between devices 110, 112, 114 and 116. For example, the network switch 120 can have a lowest latency in the network architecture 100, with respect to communication between devices 110, 112, 114 and 116. The network switch 122 can correspond at least partially in one or more of structure and operation to the network switch 120, and can correspond to a second discrete portion of the lower network layer 104 distinct from the first discrete portion of the lower network layer 104. For example, the network switch 120 can have a lowest latency in the network architecture 100, with respect to communication between any or all of the devices 112. The network switch 124 can correspond at least partially in one or more of structure and operation to the network switch 120, and can correspond to a third discrete portion of the lower network layer 104 distinct from the first and second discrete portions of the lower network layer 104. For example, the network switch 124 can have a lowest latency in the network architecture 100, with respect to communication between any or all of the devices 114. The network switch 126 can correspond at least partially in one or more of structure and operation to the network switch 120, and can correspond to a fourth discrete portion of the lower network layer 104 distinct from the first, second, and third discrete portions of the lower network layer 104. For example, the network switch 126 can have a lowest latency in the network architecture 100, with respect to communication between any or all of the devices 116. This technical solution is not limited to the number or type of network switches 120, 122, 124 and 126 depicted by way of example in the network architecture 100. The network switches 120, 122, 124 and 126 are not limited to a same latency or bandwidth.

The network switch 130 can correspond to a first discrete portion of the higher network layer 106 having a latency or range of latencies with respect to communication across devices 110, 112, 114 and 116. For example, the network switch 130 can have an intermediate latency in the network architecture 100, with respect to communication across devices 110, 112, 114 and 116. The latency of network switch 130 can correspond to a latency caused by transmission from a device in a first portion of the first layer 104 to a device in a second portion of the device layer coupled via a path including the network switch 130 or 132. The network switch 132 can correspond at least partially in one or more of structure and operation to the network switch 130, and can correspond to a first discrete portion of the higher network layer 106 distinct from the first discrete portion of the higher network layer 106. This technical solution is not limited to the number or type of network switches 130 and 132 depicted by way of example in the network architecture 100. The network switches 130 and 132 are not limited to a same latency or bandwidth.

The network switch 140 can connect the root network layer 108 with the higher network layer 106, and can have a latency or range of latencies with respect to communication across devices 110, 112, 114 and 116 via the network switch 130 or 132. For example, the network switch 140 can have a highest latency in the network architecture 100, with respect to communication across devices 110, 112, 114 and 116. The latency of network switch 130 can correspond to a latency caused by transmission from a device in a first portion of the first layer 104 to a device in a second portion of the device layer coupled via a path including the network switch 130 or 132 and the network switch 140. The network switches 120, 122, 124, 126, 130, 132 and 140 can correspond, for example, to a wired or wireless network communication channel between any or all of the devices 110.

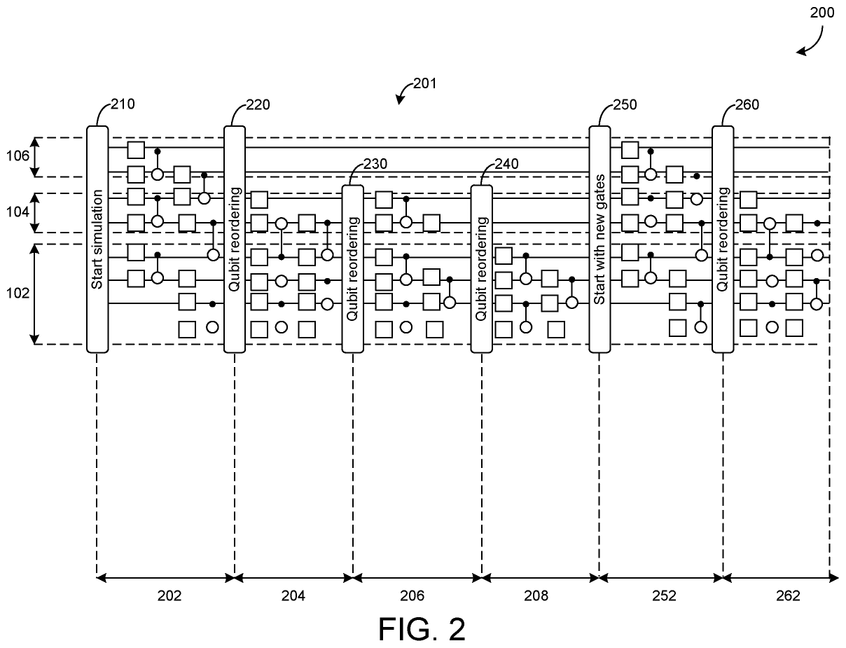

FIG. 2 depicts a progression of optimization of an example quantum circuit architecture, in accordance with present implementations. As illustrated by way of example in FIG. 2, an example progression of optimization of quantum circuit architecture 200 can include at least a first portion 202 of a quantum circuit 201, a first-level reordering of a portion 204 of the quantum circuit 201, a second-level reordering of a portion 206 of the quantum circuit 201, a third-level reordering of a portion 208 of the quantum circuit 201, a reordering of a portion 252 of the quantum circuit 201, reordering of a portion 262 of the quantum circuit 201, a simulation start event 210, a first qubit reordering event 220, a second qubit reordering event 230, a third qubit reordering event 240, a second initial quantum gate layer allocation 250, and a fourth qubit reordering event 260. For example, the architecture 200 can correspond to a structure of a simulated quantum circuit having one or more quantum gates and one or more qubits. The architecture 200 can correspond to a simulated quantum circuit 201 having portions thereof allocated to various devices of the architecture 100. One or more portions of the simulated quantum circuit of the architecture 200 can be assigned to corresponding layers 102, 104, 106 or 108, based on the particular devices and the latency between those particular devices at which the portions of the quantum circuit are simulated. For example, the quantum circuit 201 can be optimized for execution according to a particular network topology in one or more subsets. For example, a subset can correspond to a maximum number of gates, qubits, network layers, devices, time points, time periods, or any combination thereof that can be concurrently reordered. For example, the architecture can reorder a first subset of the quantum circuit architecture corresponding to portions 202, 204, 206 and 208, and can subsequently reorder a second subset of the quantum circuit architecture corresponding to portions 252 and 262.

The first quantum gate circuit portion 202 can include a first portion (e.g., a set of quantum gates) of the simulated quantum circuit of the architecture 200 having a first distribution across network layers 102, 104 and 106. Thus, simulation of the first quantum gate circuit portion 202 can be performed at a latency corresponding to data transfers between nodes in the network layer 106. The first quantum gate circuit portion 202 can have a first complexity requiring a distribution of quantum gates across all of network layers 102, 104 and 106. For example, the first quantum gate circuit portion 202 can have a number of quantum gates that must be distributed across a number of devices that exceed a number of the devices 110 and the devices 112.

The first-level reordering of the quantum circuit portion 204 can be reordered to have a second distribution across network layers 102 and 104. Thus, simulation of the first-level reordered quantum circuit 204 can be performed at a latency corresponding to the network layer 104, lower than a latency of the first quantum gate circuit portion 202. The first-level reordered quantum circuit 204 can have a second complexity requiring a distribution of quantum gates across all of network layers 102 and 104. For example, the first-level reordered quantum circuit 204 can have a number of quantum gates that must be distributed across a number of devices that require compute resources (e.g., memory) that exceed the resources available to a number of the devices 110. The second-level reordered quantum circuit 206 can correspond at least partially in one or more of structure and operation to the first-level reordered quantum circuit 204, and can include one or more quantum gates arranged in a quantum logical structure distinct from the quantum logical structure of the first-level reordered quantum circuit 204. For example, the second-level reordered quantum circuit 206 can include quantum gates distinct from the quantum gates of the first-level reordered quantum circuit 204, in an arrangement distinct from the quantum gates of the first-level reordered quantum circuit 204.

The third-level reordered quantum circuit 208 can include a third portion of the simulated quantum circuit of the architecture 200 having a third distribution in network layer 102. Thus, simulation of the third-level reordered quantum circuit 208 can be performed at a latency corresponding to the device layer 102, lower than a latency of the first quantum gate circuit portion 202 and the first-level reordered quantum circuit 204. The third-level reordered quantum circuit 208 can have a third complexity allowing a distribution of quantum gates within the device layer 102. For example, the third-level reordered quantum circuit 208 can have a number of quantum gates that can be accommodated across a number of devices at or below a number of the devices 110.

The simulation start event 210 can correspond to an initialization or activation of a quantum circuit 201, including an initialization or activation of one or more qubits of the quantum circuit. For example, the quantum circuit 201 can include one or more of the portions 202, 204, 206, 208, 252 and 262. The simulation start event 210 can initialize or set values of a quantum state vector for one or more qubits corresponding to the qubits of the simulated quantum circuit. The simulation start event 210 can allocate portions of one or more quantum state vectors to devices of the architecture 100, to result in the layer distribution of architecture 200.

The first qubit reordering event 220 can correspond to a swap of one or more qubits (and corresponding quantum gates) between layers of the architecture 200. For example, the first qubit reordering event 220 can swap a portion of a state vector corresponding to a particular qubit from a node in network layer 106 to a node in network layer 104, in response to a determination that a latency of the swapped gates can be reduced. For example, the first qubit reordering event 220 can swap a portion of the simulated quantum gate circuit from the network layer 106 to the network layer 104, where the network layer 104 includes a portion of the simulated quantum circuit having a complexity lower than a complexity of the circuit moved to the network layer 106. The second qubit reordering event 230 can correspond at least partially in one or more of structure and operation to first qubit reordering event 220.

The third qubit reordering event 240 can correspond to a swap of one or more qubits (and their corresponding quantum gates) between layers of the architecture 200. For example, the third qubit reordering event 240 can swap a portion of a state vector corresponding to a particular qubit from network layer 104 to device layer 102, in response to a determination that a latency of simulating (including data transfer time) the swapped qubits can be reduced. For example, the third qubit reordering event 240 can swap a portion of the simulated quantum gate circuit from the network layer 104 to the device layer 102, where the device layer 102 includes a portion of the simulated quantum circuit having a complexity lower than a complexity of the circuit moved to the network layer 104.

The second initial quantum gate layer allocation 250 can include a further quantum gate circuit portion 252 and can correspond at least partially in one or more of structure and operation to first quantum gate circuit portion 202, and can include one or more quantum gates arranged in a quantum logical structure distinct from the quantum logical structure of the first quantum gate circuit portion 202. The fourth qubit reordering event 260 can include a further quantum gate circuit portion 262 and can correspond at least partially in one or more of structure and operation to the first qubit reordering event 220. For example, qubit reordering can be recursively performed on gates of lower network levels before being performed on gates at higher network levels. Thus, complexity can be maximized at lower levels of architecture 100. Thus, the qubit reordering events 220, 230, 240 and 260 can provide a technical improvement of at least faster execution of the simulated quantum circuit by the technical solution of swapping portions of a simulated quantum circuit based on network latency and complexity of swapped quantum circuit portions.

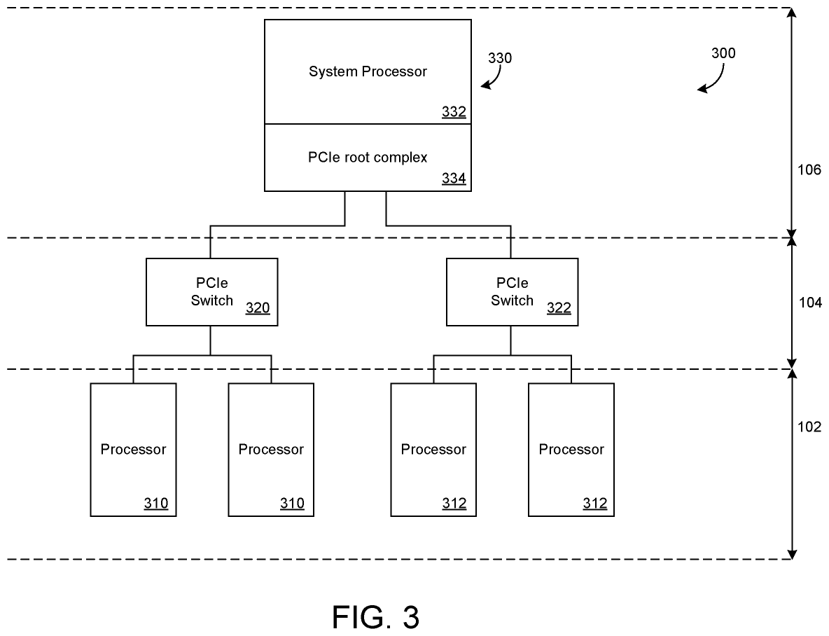

FIG. 3 depicts an example network architecture, in accordance with present implementations. As illustrated by way of example in FIG. 3, an example network architecture 300 can include at least processors 310, processors 312, a switch 320, a switch 322, and a root node 330. This technical solution is not limited to the number or type of processors, switches, or root nodes as illustrated in network architecture 300 by way of example. For example, the network architecture can have a structure including three layers, in which the processors 310 and 312 correspond to the device layer 102, the switches 320 and 322 correspond to the first layer 104, and the root node 330 corresponds to the root layer 108.

The processors 310 can each include, but are not limited to, at least one graphics processing unit (GPU), physics processing unit (PPU), embedded controller (EC), gate array, programmable gate array (PGA), field-programmable gate array (FPGA), application-specific integrated circuit (ASIC), at least one core thereof, or any combination thereof. The processor 310 can execute one or more instructions in a parallelized order in accordance with one or more parallelized instruction parameters. The processors 310 or corresponding cores thereof can be assigned to, associated with, configured to, or fabricated to, execute instructions or operations corresponding to a portion or subset of the instructions or operations of the simulated quantum circuit, one or more state vectors or portions thereof of the simulated quantum circuit, or any combination thereof. For example, the processors 310 can correspond to the devices 110. The processors 312 can correspond at least partially in one or more of structure and operation to the processor 312. For example, the processors 312 can correspond to the devices 112. The switches 320 and 322 can respectively correspond at least partially in one or more of structure and operation to the network switches 130 and 132. The switches can operate in accordance with a Component Interconnect Express (PCIe) architecture, but are not limited thereto.

The root node 330 can correspond at least partially in one or more of structure and operation to the network switch 140. The root node 330 can include a system processor 332, and a Peripheral PCIe root complex 334.

The system processor 332 can execute one or more instructions associated with the network architecture 300. The system processor 332 can include an electronic processor, an integrated circuit, or the like including one or more of digital logic, analog logic, digital sensors, analog sensors, communication buses, volatile memory, nonvolatile memory, and the like. The system processor 332 can include, but is not limited to, at least one microcontroller unit (MCU), microprocessor unit (MPU), central processing unit (CPU), graphics processing unit (GPU), physics processing unit (PPU), embedded controller (EC), or the like. The system processor 332 can include a memory operable to store or storing one or more instructions for operating components of the system processor 332 and operating components operably coupled to the system processor 332. For example, the one or more instructions can include one or more of firmware, software, hardware, operating systems, or embedded operating systems. The system processor 332 or the network architecture 300 generally can include a communication bus controller to effect communication between the system processor 332 and the other elements of the network architecture 300.

The PCIe root complex 334 can communicate one or more instructions, signals, conditions, states, or the like between one or more of the processors 310 and 312. The PCIe root complex 334 can include one or more digital, analog, or like communication channels, lines, traces, or any combination thereof. For example, the PCIe root complex 334 can include at least one serial or parallel communication line among multiple communication lines of a communication interface. The PCIe root complex 334 can operate in accordance with a Component Interconnect Express (PCIe) architecture, but are not limited thereto.

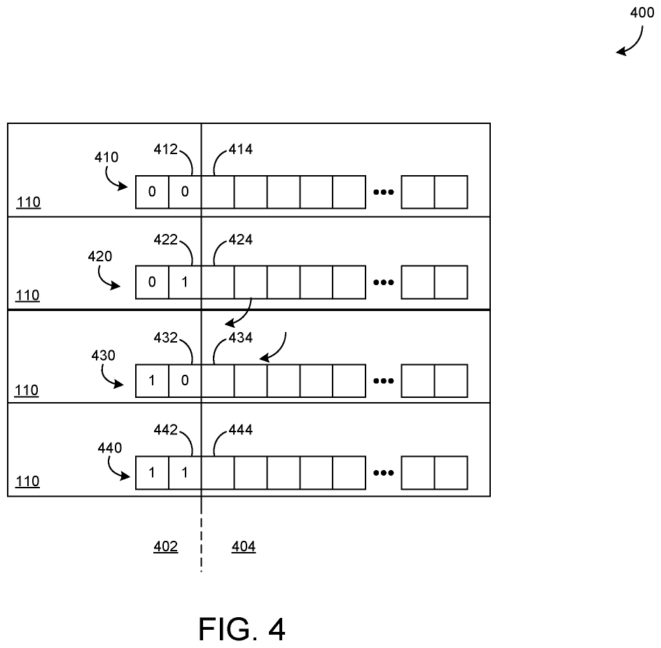

FIG. 4 depicts an example quantum state vector architecture, in accordance with present implementations. As illustrated by way of example in FIG. 4, an example quantum state vector architecture 400 can include at least global index bits 402, local index bits 404, a first portion 410 of a state vector, a second portion 420 of a state vector, a third portion 430 of a state vector, and a fourth portion 440 of a state vector. In one or more embodiments, each portion may correspond to a separate simulated qubit. The global index bits 402 can be used to identify the ordinal of portions of a state vector distributed to devices, and can correspond to portions of a quantum state vector stored at a device 112, 114 or 116 coupled with the device 110 via a network switch 120, 130, or 140. The local index bits 404 can correspond to portions of a quantum state vector stored at a given one of the devices 110.

The first portion 410 of a state vector 410 store at least a portion of a simulated quantum state of a first simulated qubit. The first portion 410 of the state vector can include a first global swap bit 412, and a first local swap bit 414. The first global swap bit 412 can correspond to a particular bit of the first portion 410 of the state vector among the global index bits 402. The first global swap bit 412 can be selected or designated for swapping with the first local swap bit 414. The first local swap bit 414 can correspond to a particular bit of the first portion 410 of the state vector among the local index bits 404. The first local swap bit 414 can be selected or designated for swapping with the first global swap bit 412.

The second portion 420 of a state vector can store at least a portion of a simulated quantum state of a second simulated qubit. The second portion 420 of the state vector can include a second global swap bit 422, and a second local swap bit 424. The second global swap bit 422 can correspond to a particular bit of the second portion 420 of the state vector among the global index bits 402. The second global swap bit 422 can be selected or designated for swapping with the second local swap bit 424. The second local swap bit 424 can correspond to a particular bit of the second portion 420 of the state vector among the local index bits 404. The second local swap bit 424 can be selected or designated for swapping with the second global swap bit 422.

The third portion 430 of a state vector can store at least a portion of a simulated quantum state of a third simulated qubit. The third portion 430 of the state vector can include a third global swap bit 432, and a third local swap bit 434. The third global swap bit 432 can correspond to a particular bit of the third portion 430 of the state vector among the global index bits 402. The third global swap bit 432 can be selected or designated for swapping with the third local swap bit 434. The third local swap bit 434 can correspond to a particular bit of the third portion 430 of the state vector 430 among the local index bits 404. The third local swap bit 434 can be selected or designated for swapping with the third global swap bit 432.

The fourth portion 440 of a state vector can store at least a portion of a simulated quantum state of a fourth simulated qubit. The fourth portion 440 of the state vector can include a fourth global swap bit 442, and a fourth local swap bit 444. The fourth global swap bit 442 can correspond to a particular bit of the fourth portion 440 of the state vector among the global index bits 402. The fourth global swap bit 442 can be selected or designated for swapping with the fourth local swap bit 444. The fourth local swap bit 444 can correspond to a particular bit of the fourth portion 440 of the state vector among the local index bits 404. The fourth local swap bit 444 can be selected or designated for swapping with the fourth global swap bit 442.

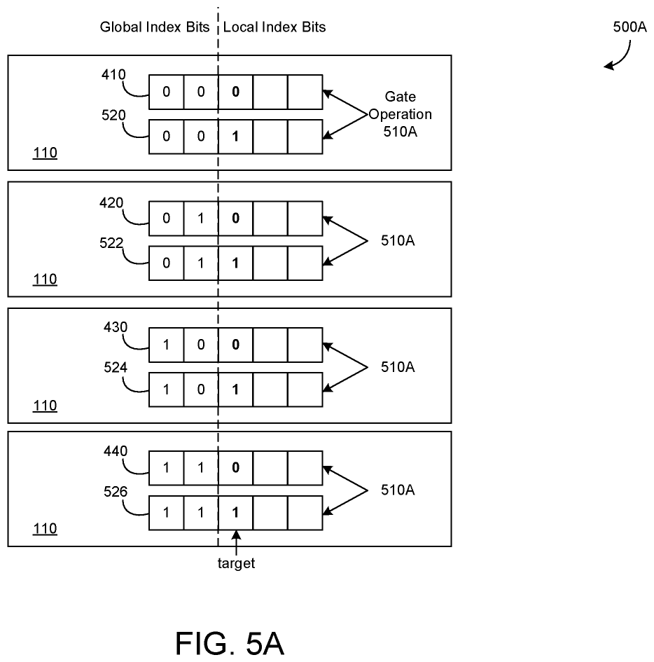

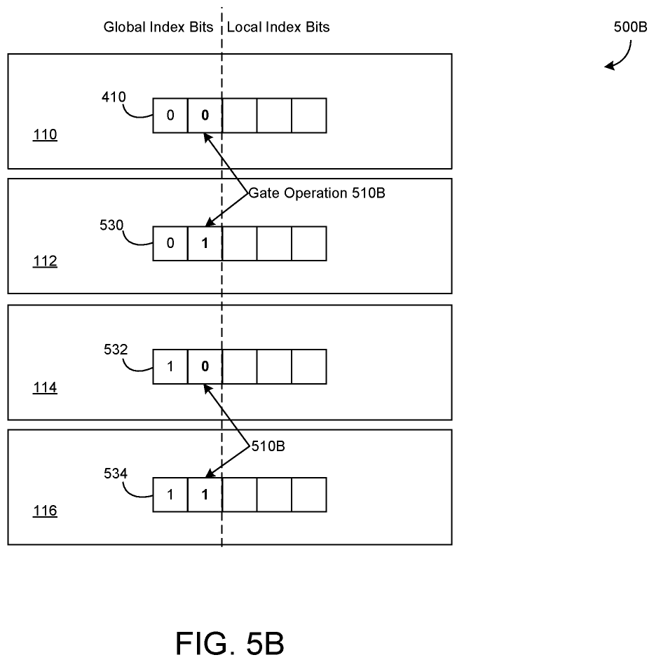

FIG. 5A depicts an example quantum state vector architecture during a gate operation that does not execute a local quantum state vector swap operation, in accordance with present implementations. As illustrated by way of example in FIG. 5A, an example simulated quantum circuit 500A can include at least a gate operation 510A, a first portion of a state vector representing a first set of global qubits 410 a second portion of a state vector representing a set of global qubits 420, a third portion of a state vector representing a third set of qubits 430, and a fourth portion of a state vector representing a set of qubits 440. As depicted in FIG. 5A, the first portion of a state vector may be further distributed into a first subset 410 and a second subset 520, each representing a different quantum state (e.g., either 0 or 1). The second portion of the state vector (corresponding to a second qubit) may be further distributed into a first subset 420, and a second subset 522, each representing different quantum states of the second qubit, respectively. The third portion of the state vector (corresponding to a third qubit) may be further distributed into a first subset 430, and a second subset 524, each representing different states of the third qubit, respectively. The fourth portion of the state vector (corresponding to a fourth qubit) may be further distributed into a first subset 440, and a second subset 526, each representing different binary states of the fourth qubit, respectively. The gate operation 510A can correspond to a simulated quantum gate operation on a quantum state vector of two qubits within each device 110. For example, the gate operation 510A can correspond to a gate operation of a controlled not gate coupled with (for example and without limitation) two qubits executable within each device 110. In additional or alternative examples, the gate application may be implemented using an application of a single qubit gate, or more than two qubit gates.

The first subset 410 of the qubit state vector can store some (e.g., half) of a first portion of a state vector while the second subset 520 of the state vector can also store some (e.g., the remainder) of the first portion of the first quantum state vector corresponding to the same (first) qubit. The one or more bits of the second subset 520 can be modified by the gate operation 510A with respect to one or more bits of the first subset 410. The first subset 420 and second subset 522 of the second portion of the state vector can collectively store a second portion of the state vector. The one or more bits of the second subset 522 can be modified by the gate operation 510A with respect to one or more bits of the first subset 420 of the second portion of the state vector. The first subset 430 and second subset 524 of a third portion of the state vector can collectively store a third portion of the state vector, corresponding to the third qubit. The one or more bits of the second subset 524 can be modified by the gate operation 510A with respect to one or more bits of the first subset of the third portion of the state vector. The first subset 440 and second subset 526 of the fourth portion of the state vector can collectively store the fourth portion of the quantum state vector, corresponding to the fourth qubit. The one or more bits of the second subset 526 can be modified by the gate operation 510A with respect to one or more bits of the first subset 440 of the fourth portion of state vector.

FIG. 5B depicts an example scenario that may benefit from a vector swap operation, in accordance with present implementations. As illustrated by way of example in FIG. 5B, an example first level quantum state vector swap operation 500B can include at least a gate operation 510B, a first portion 410 of a state vector, a first subset 530 of a second portion of the state vector, a second subset 532 of the second portion of the state vector, and a third subset 534 of the second portion of the state vector. The gate operation 510B can correspond to a simulated quantum gate operation on a quantum state vector of two qubits distributed across two or more of the devices 110, 112, 114, and 116. For example, the gate operation 510B can correspond to a gate operation of a controlled not gate coupled with two qubits executable between two or more of the devices 110 and 112, or between two or more of the devices 114 and 116.

The first subset 530 of the second portion of the state vector can store, at a device 112 coupled with the device 110 via the network switch 130, a first subset (e.g., the first ⅓) of a second portion of a quantum state vector corresponding to a second qubit. The one or more bits of the first subset 530 of the state vector can be modified by the gate operation 510B with respect to one or more bits of the first portion 410 of the state vector. Here, the latency of the gate operation 510B can be increased for a gate operation corresponding to two distinct qubits, where the respective portions of the state vector for each of the qubits are distributed across the network layers of the architecture 100.

The second subset 532 of the second portion of the state vector can store, at a device 114, a second subset (e.g., the second ⅓) of the second portion of the state vector. The third subset 534 of the second portion of the state vector can store, at a device 116 coupled with the device 114 via the network switch 132, a third subset (e.g., the remaining ⅓) of the second portion of the state vector. Here, the latency of the gate operation 510B may be higher than a gate operation corresponding to a single qubit, due to the distribution of different subsets of the same portion (e.g., the first subset 530 being distributed across different network layers of the architecture 100. In an example scenario, a swap operation may be performed to swap the simulation of the first subset 530 of the second qubit from device 112 from its previous allocation at device 112 to device 116, which shares a network switch with device 114. The gate operations represented using the first 530 and second 532 subsets of the second portion of the state vector may be executed in devices 114 and 116, respectively. During the next recursive iteration, the mapping of the processing node(s) in device 116 may be swapped from the first subset 530 to the third subset 534, operations (e.g., computations) represented using the third subset 534 may be executed, and the output from execution of the third subset 534 may be combined/collapsed with the output of the execution of the first and second subsets 532 to complete the operations for simulating the second portion of the state vector (e.g., the second qubit).

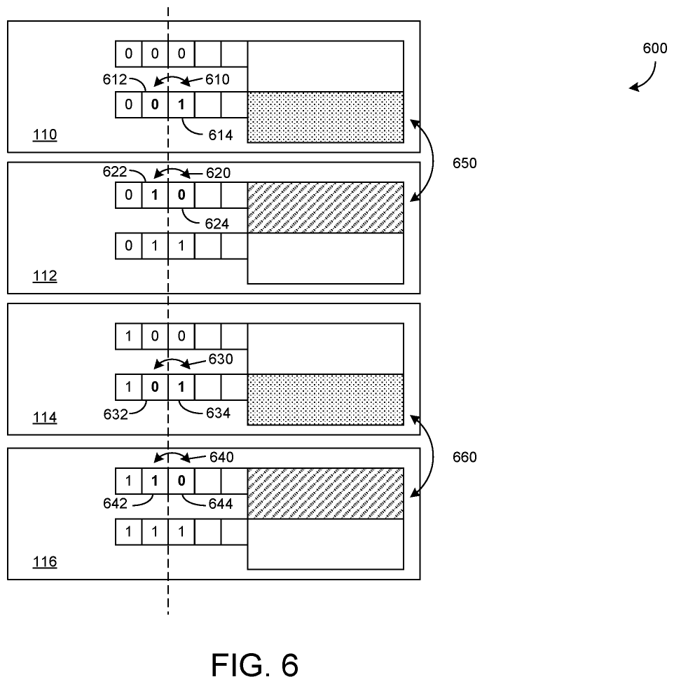

FIG. 6 depicts an example global quantum state vector swap operation, in accordance with present implementations. As illustrated by way of example in FIG. 6, an example global quantum state vector swap operation 600 can include at least a first global bit swap operation 610, a second global bit swap operation 620, a third global bit swap operation 630, a fourth global bit swap operation 640, a first vector state swap operation 650, and a second vector state swap operation 660.

The first global bit swap operation 610 can be performed in response to a determination of a predetermined bit states of one or more bits of a quantum state vector. The first global bit swap operation 610 can be based on a first global index bit 612, and a first local index bit 614. The first global index bit 612 can indicate a zero state, and can correspond to a global index bit 402. The first local index bit 614 can indicate a one state, and can correspond to a local index bit 404. For example, the first global bit swap operation 610 can be performed in response to determination that the first global index bit 612 and the first local index bit 614 have different states. For example, the first global bit swap operation 610 may be skipped in response to determination that the first global index bit 612 and the first local index bit 614 have the same or corresponding states (e.g., bit values). The second global bit swap operation 620 can correspond at least partially in one or more of structure and operation to the first global bit swap operation 610. The second global bit swap operation 620 can be based on a second global index bit 622, and a second local index bit 624. The second global index bit 622 can indicate a one state, and can correspond to a global index bit 402. The second local index bit 624 can indicate a zero state, and can correspond to a local index bit 404.

The third global bit swap operation 630 can correspond at least partially in one or more of structure and operation to the first global bit swap operation 610. The third global bit swap operation 630 can be based on a third global index bit 632, and a third local index bit 634. The third global index bit 632 can indicate a zero state, and can correspond to a global index bit 402. The third local index bit 634 can indicate a one state, and can correspond to a local index bit 404. The fourth global bit swap operation 640 can correspond at least partially in one or more of structure and operation to the first global bit swap operation 610. The fourth global bit swap operation 640 can be based on a fourth global index bit 642, and a fourth local index bit 644. The fourth global index bit 642 can indicate a one state, and can correspond to a global index bit 402. The fourth local index bit 644 can indicate a zero state, and can correspond to a local index bit 404.

The first vector state swap operation 650 can correspond to a swap of one or more bits of a portion of a quantum state vector stored at the device 110 with one or more bits of another portion of the quantum state vector stored at the device 112. For example, the first vector state swap operation 650 can swap all of the bits of the portion of the quantum state vector stored at the device 110 with all of the bits of the other portion of the quantum state vector stored at the device 112. Thus, this technical solution can provide at least the technical improvement of reducing data transfer latency by swapping distributed portions of a quantum state vector between devices of the architecture 100 used to simulate a quantum circuit. For example, the first vector state swap operation 650 can be performed in response to a determination that the first global bit swap operation 610 and the second global bit swap operation 620 have been performed, or can be performed. Thus, the first vector state swap operation 650 can be performed responsive to one or both of the first global bit swap operation 610 and the second global bit swap operation 620. The second vector state swap operation 660 can correspond at least partially in one or more of structure and operation to the first vector state swap operation 650, and can be responsive to one or both of the third global bit swap operation 630 and the fourth global bit swap operation 640.

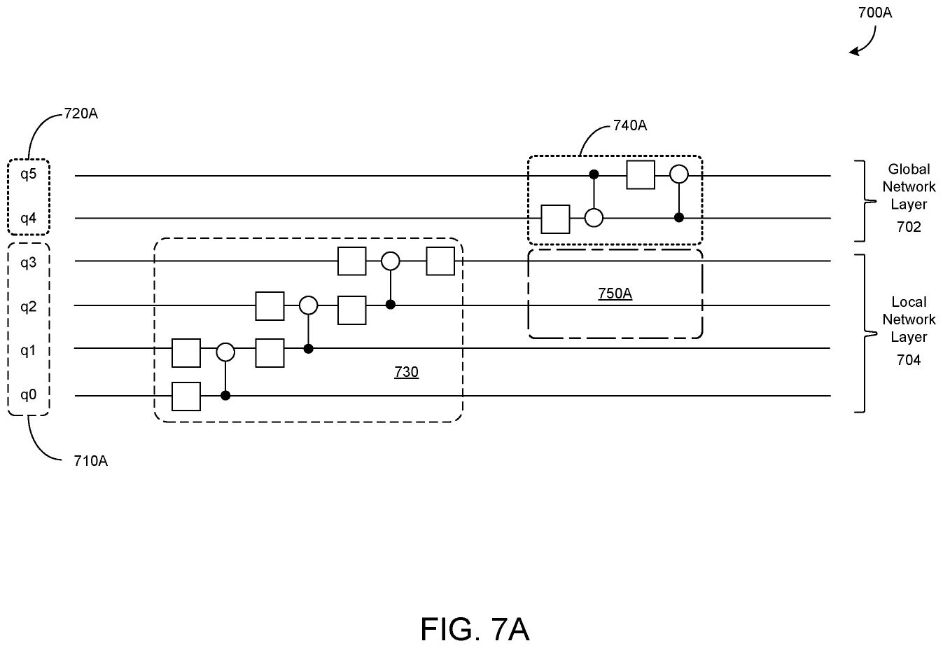

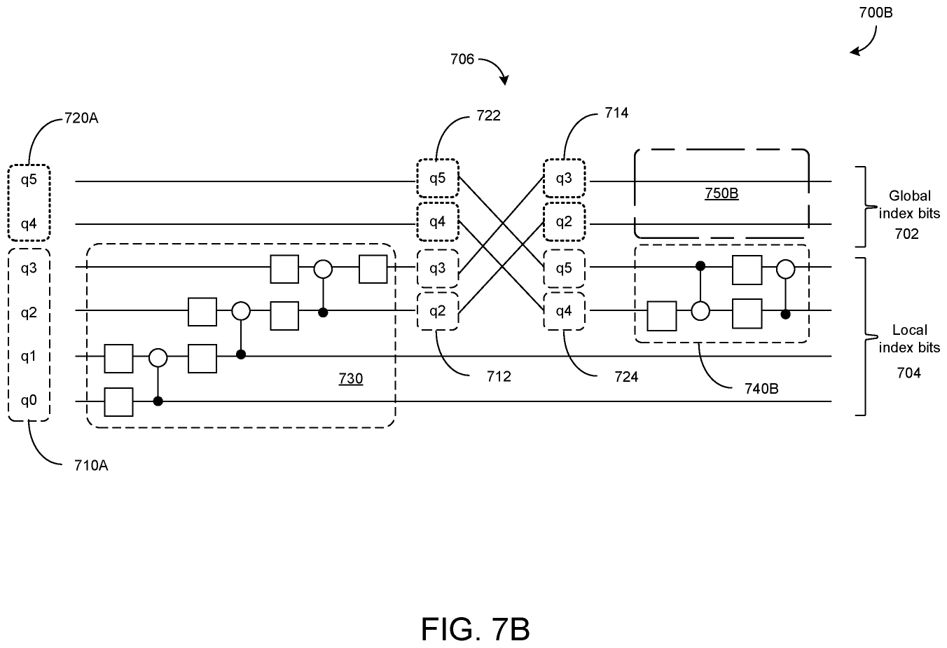

FIG. 7A depicts an example diagram of an identification of a swap for a quantum circuit across network levels, in accordance with present implementations. As illustrated by way of example in FIG. 7A, an example diagram of an identification of a swap for a quantum circuit across network levels 700A can include at least global network layer 702, local network layer 704, a first plurality of qubits at a local network level 710A, a second plurality of qubits 720A at a global network level, a first quantum circuit portion 730, a second quantum circuit portion 740A, and a third quantum circuit portion 750A. The global network layer 702 and the local network layer 704 can respectively correspond to the global and local index bits 402 and 404.

The first plurality of qubits 710A at a local network level can be associated with one or more devices at a device layer 102 or a network layer 104 or 106, of the architecture 100. For example, the first plurality of qubits 710A can have different portions of a state vector allocated to devices on the device layer 102, or on the lower network layer 104. For example, a local network level can correspond to the device layer 102, or can correspond to any network layer corresponding to a particular portion of a simulated quantum circuit. The second plurality of qubits 720A at a global network level can be associated with one or more devices at a network layer of the architecture 100 at a layer of the architecture 100 having a latency higher than a layer of the first plurality of qubits 710A. For example, the first plurality of qubits 710A can have portions of a state vector allocated to devices via the lower network layer 104 or the higher network layer 106.

The first quantum circuit portion 730 can correspond to a portion of a simulated quantum circuit coupled with the first plurality of qubits 710A. The first quantum circuit portion 730 can be executed at the local network level, and the portion of the quantum state vector corresponding to the first quantum circuit portion 730 can be stored at devices corresponding to the local network level. The first quantum circuit portion 730 can correspond to a quantum circuit structure configured to modify output of the first plurality of qubits 710A.

The second quantum circuit portion 740A can correspond to a portion of a simulated quantum circuit coupled with the second plurality of qubits 720A. The second quantum circuit portion 740A can be executed at the global network level, and the portion of the quantum state vector corresponding to the second quantum circuit portion 740A can be stored at devices corresponding to the global network level. The second quantum circuit portion 740A can correspond to a quantum circuit structure configured to modify output of the second plurality of qubits 720A and to provide output to a further portion of the simulated quantum circuit or a measurement circuit to complete the quantum computation and collapse the simulated quantum states of the qubits 710A and 720A.

The third quantum circuit portion 750A can correspond to a quantum circuit structure configured to provide output to a further portion of the simulated quantum circuit or a measurement circuit to complete the quantum computation and collapse the simulated quantum states of the qubits 710A and 720A. For example, the third quantum circuit portion 750A can include leads to a measurement circuit and be absent any quantum gates. Thus, since the third quantum circuit portion 750A has no quantum gates in this example, and the second quantum circuit portion 740A has four quantum gates, the second quantum circuit portion 740A has a complexity higher than the third quantum circuit portion 750A.

FIG. 7B depicts an example diagram of a swap operation for a quantum circuit across network levels, in accordance with present implementations. As illustrated by way of example in FIG. 7B, an example diagram of a swap operation for a quantum circuit across network levels 700B can include at least a first plurality of unswapped qubits at a local network level 712, a first plurality of swapped qubits at a global network level 712, a first plurality of unswapped qubits at a global network level 714, a first plurality of swapped qubits at a local network level 712, a first swapped quantum circuit portion 740B, and a second swapped quantum circuit portion 750B.

The first plurality of unswapped qubits 712 at a local network level can correspond to portions of a quantum state vector of a number of the first plurality of qubits 710A. For example, the first plurality of unswapped qubits 712 can include a subset of the first plurality of qubits 710A. The first plurality of unswapped qubits 722 at a global network level can correspond to portions of the quantum state vector of a number of the second plurality of qubits 720A. For example, the first plurality of unswapped qubits 722 can include a subset of the second plurality of qubits 720A that matches a number of the first plurality of unswapped qubits 712.

The first plurality of swapped qubits 714 at a global network level can correspond to portions of a quantum state vector of the first plurality of unswapped qubits 712. For example, the first plurality of swapped qubits 714 can be swapped in response to a swap of portions (e.g., elements) of the quantum state vector of the first plurality of unswapped qubits 712 from devices at a local network level to devices at a global network level. The first plurality of swapped qubits at a local network level 724 can correspond to portions of a quantum state vector of the first plurality of unswapped qubits 722. For example, the first plurality of swapped qubits 724 can be swapped in response to a swap of the portions (elements) of the quantum state vector of the first plurality of unswapped qubits 722 from devices at a global network level to devices at a local network level.

The first swapped quantum circuit portion 740B can correspond at least partially in one or more of structure and operation to the second quantum circuit portion 740A, and can be allocated to a local network level. For example, one or more portions of a quantum state vector of the qubits 724 can be allocated to devices at the local network level, and can be modified by the devices at the local network level according to the first swapped quantum circuit portion 740B. The second swapped quantum circuit portion 750B can correspond at least partially in one or more of structure and operation to the third quantum circuit portion 750A, and can be allocated to a global network level. For example, one or more portions of a quantum state vector of the qubits 724 can be distributed to devices at the local network level, and can be modified by the devices at the local network level according to the first swapped quantum circuit portion 740B. Alternatively, in one or more embodiments, when a state vector is apportioned and distributed to multiple devices, which may include devices (nodes) that may not be co-located in the same local network, each qubit in the simulated circuit is mapped to the index bit of a state vector and is also mapped to a layer of the network architecture.

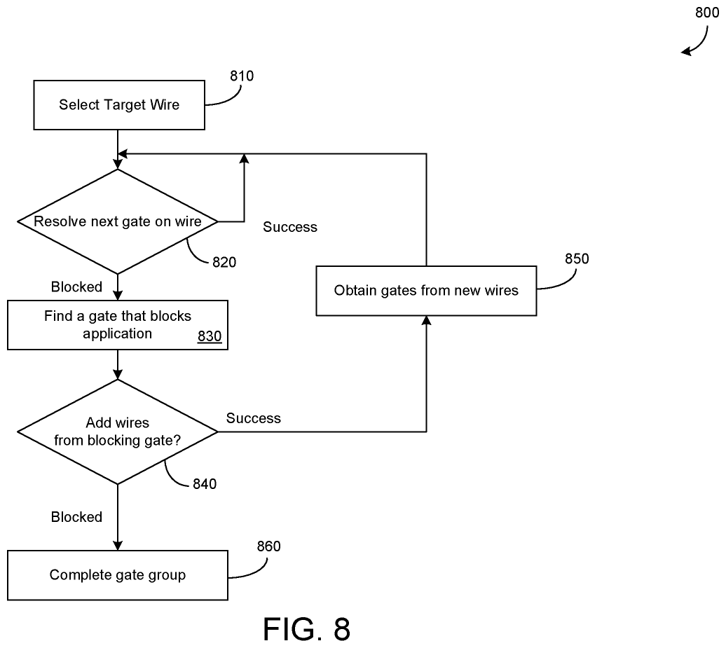

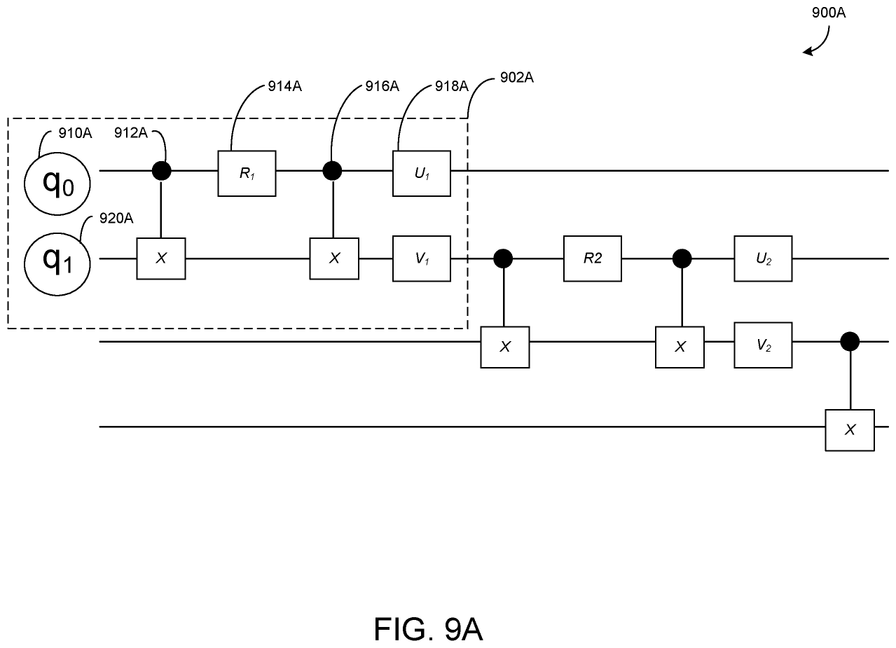

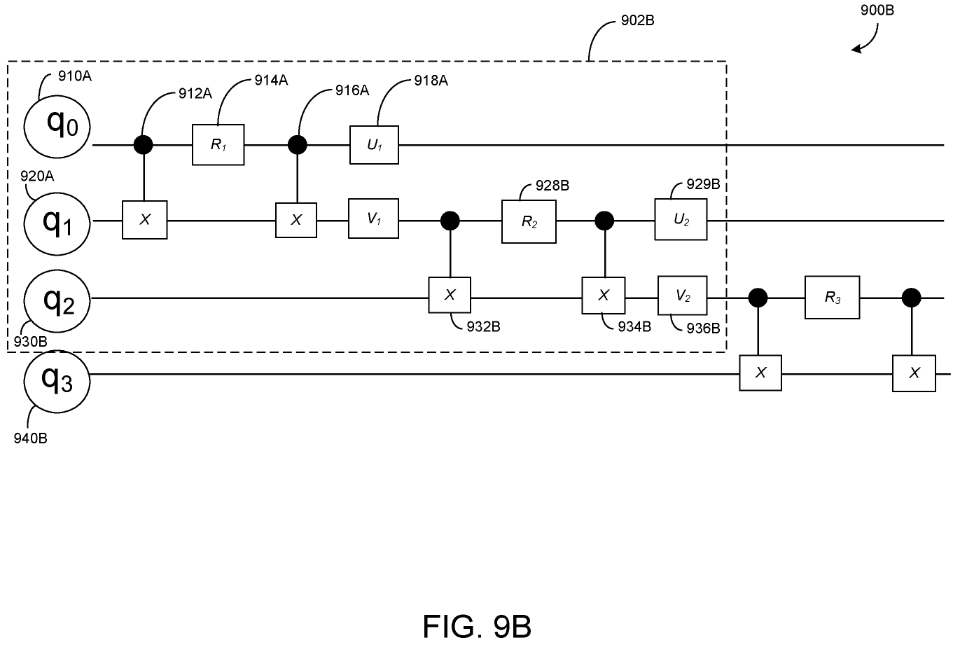

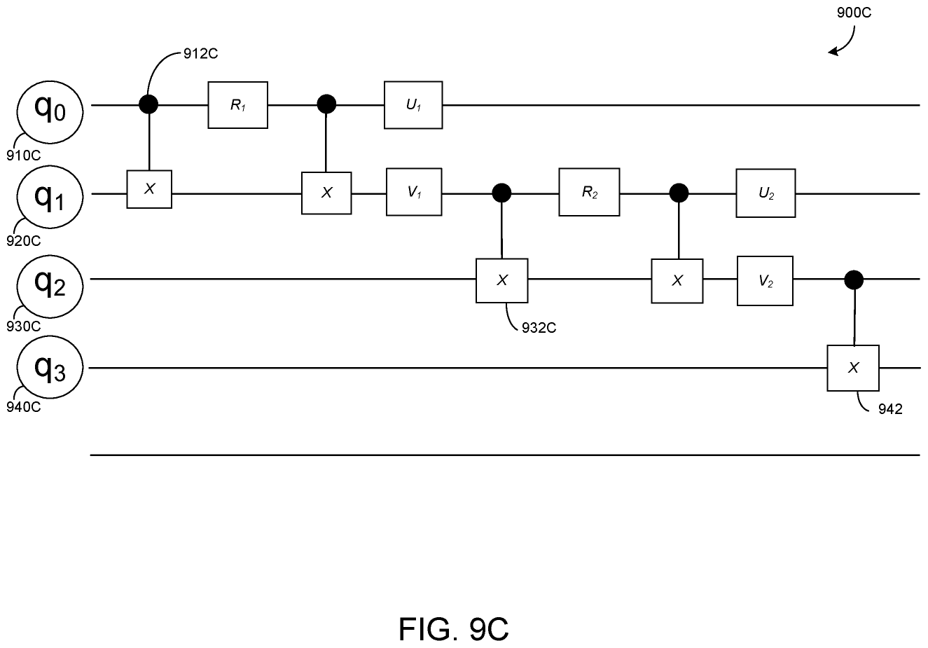

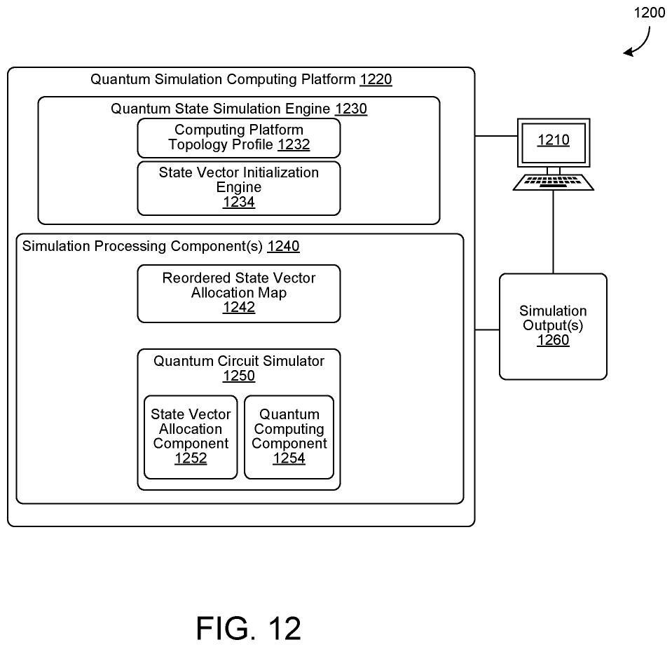

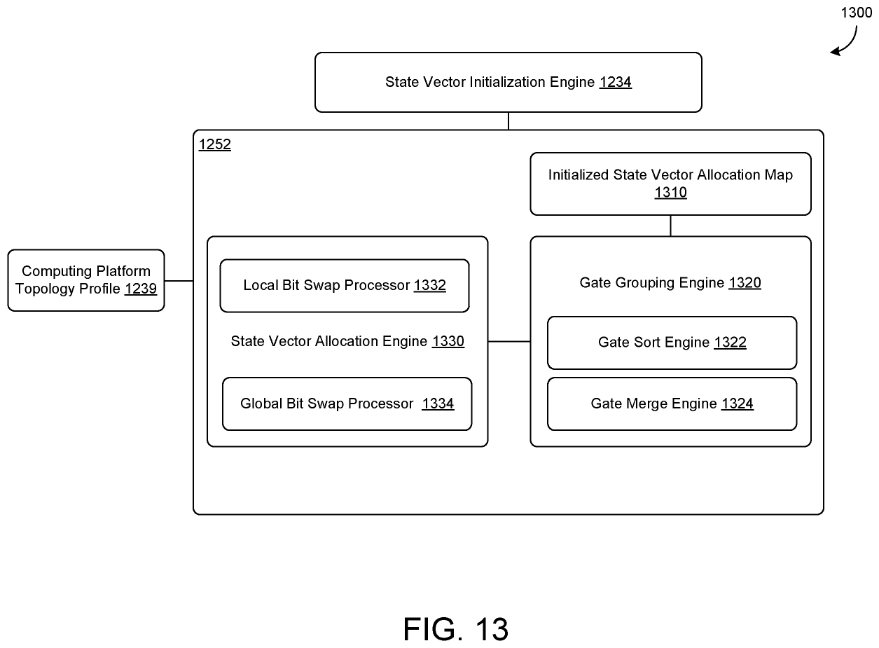

FIG. 8 depicts an example method of gate group selection, in accordance with present implementations. At least system and devices according to at least one of the architectures of FIG. 12 or FIG. 13 can perform method 800. For example, the method 800 can correspond to gate grouping operations according to FIGS. 9A-9C.

At 810, the method 800 can select a target wire. For example, a target wire can correspond to a node that couples an output of a qubit with one or more quantum gates. The method 800 can randomly select a target wire, or select a target wire in accordance with a sequence or order of qubits of a quantum circuit. At 820, the method 800 can resolve the next gate on the wire. A next gate can correspond to a quantum gate to be processing in sequence that receives the output of the qubit or the output of a gate disposed operatively between the gate and the qubit. For example, the method 800 can resolve the next gate by determining whether the next gate has an input coupled with a qubit whose target wire has not been selected. At 830, the method 800 can identify a blocking gate that blocks application of the next gate. For example, in response to a determination that next gate has an input coupled with a qubit whose target wire has not been selected, the method 800 can identify the next gate as a blocking gate.

At 840, the method 800 can determine whether to add wires from a blocking gate. For example, the method 800 can add a wire corresponding a qubit coupled with the blocking gate, in response to a determination that the addition of the qubit satisfies a threshold for a maximum number of qubits per gate group. At 850, the method 800 can obtain gates from new wires. For example, the method 800 can obtain gates from a new wire in response to a determination that the addition of the qubit satisfies a threshold for a maximum number of qubits per gate group. At 860, the method 800 can complete gate group. For example, the method 800 can complete a gate group in response to a determination that all gates on the wire have been resolved, or that a blocking gate cannot be resolved.

FIG. 9A depicts an example diagram of a selection of a two-qubit gate group, in accordance with present implementations. As illustrated by way of example in FIG. 9A, an example diagram of a selection of a two-qubit gate group 900A can include at least a two-qubit gate group 902A, a first qubit 910A, and a second qubit 920A. The two-qubit gate group 902A can include a portion of a simulated quantum circuit coupled with the first qubit 910A and the second qubit 920A. For example, formation of the two-qubit gate group 902A can begin with selection of the first qubit 910A, and can result in successful creation of the two-qubit gate group 902A.

The first qubit 910A can be coupled with a first control gate 912A, first quantum (logic) gate 914A, a second control gate 916A, and a second quantum (logic) gate 918A along a first wire of the simulated quantum circuit. To form the two-qubit gate group 902A, the first qubit 910A can be selected. The first control gate 912A can correspond to a gate dependent on input from the first qubit 910A and the second qubit 920A. For example, the first control gate 912A correspond to a controlled NOT gate. In response to a determination that the number of selected qubits, in this case one, satisfies the gate group maximum threshold of two, the second qubit 920A can be added to the two-qubit gate group 902A. The gates of the first qubit 910A can continue to be evaluated. The first quantum gate 914A can correspond to a gate having input dependent only on the first qubit 910A. For example, the first quantum gate 914A can correspond to an H gate. The first quantum gate 914A can be added to the two-qubit gate group 902A. The second control gate 916A can be added to the two-qubit gate group 902A, in response to a determination that all qubits on which the second control gate 916A is dependent for input are included in the two-qubit gate group 902A. Similarly, the second quantum gate 918A can be added to the two-qubit gate group 902A, in response to a determination that all qubits on which the second quantum gate 918A depends on for input are included in the two-qubit gate group 902A.

FIG. 9B depicts an example diagram of a selection of a three-qubit gate group, in accordance with present implementations. As illustrated by way of example in FIG. 9B, an example diagram of a selection of a three-qubit gate group 900B can include at least a three-qubit gate group 902B, a fourth quantum (logic) gate 928B, a fifth quantum (logic) gate 929B, a third qubit 930B, a third control gate 932B, a fourth control gate 934B, a sixth state gate 936B, and a fourth qubit 940B. The three-qubit gate group 902B can include a portion of a simulated quantum circuit coupled with the first qubit 910A, the second qubit 920A, and the third qubit 930B. For example, formation of the three-qubit gate group 902B can begin with selection of the first qubit 910A, can include gate group creation according to the two-qubit gate group 902A, and can result in successful creation of the three-qubit gate group 902B.

For example, the fourth quantum gate 928B can be selected according to the creation of a gate group according to the two-qubit gate group 902A process. In response to a determination that the number of selected qubits, in this case two, satisfies the gate group maximum threshold of three, the second qubit 920A can be added to the three-qubit gate group 902B, continuing the process of gate group creation beyond creation of the two-qubit gate group 902A. The fifth quantum gate 929B, the third control gate 932B, the fourth control gate 934B, and the sixth quantum gate 936B can be added to the three-qubit gate group 902B, in response to a determination that all qubits on which those gates depend for input are included in the three-qubit gate group 902B. The three-qubit gate group 902B can be completed in response to identification of a blocking gate having input dependent on the fourth qubit 940B.

FIG. 9C depicts an example diagram of blocking of a gate group, in accordance with present implementations. As illustrated by way of example in FIG. 9C, an example diagram of blocking of a gate group 900C can include at least a fourth qubit 910C, a third qubit 920C, a second qubit 930C, and a first qubit 940C. A creation of a gate group can fail for a portion of a simulated quantum circuit coupled with the first qubit 940C, the second qubit 930C, the third qubit 920C, and the fourth qubit 910C. For example, an attempt at formation of a gate group can begin with selection of the first qubit 940C, and can result in failure to create a gate group.

For example, a controlled gate 942 can block the creation of a gate group on the wire coupled with the first qubit 940C. A controlled gate 932C can block the creation of a gate group on the wire coupled with the second qubit 930C. A controlled gate 912C can block the creation of a gate group on the wire coupled with the fourth qubit 910C. Thus, the cascading dependencies of the controlled gates 942, 932C and 912C can prevent the creation of a gate group, where the threshold for a maximum size of the gate group is two or three qubits.

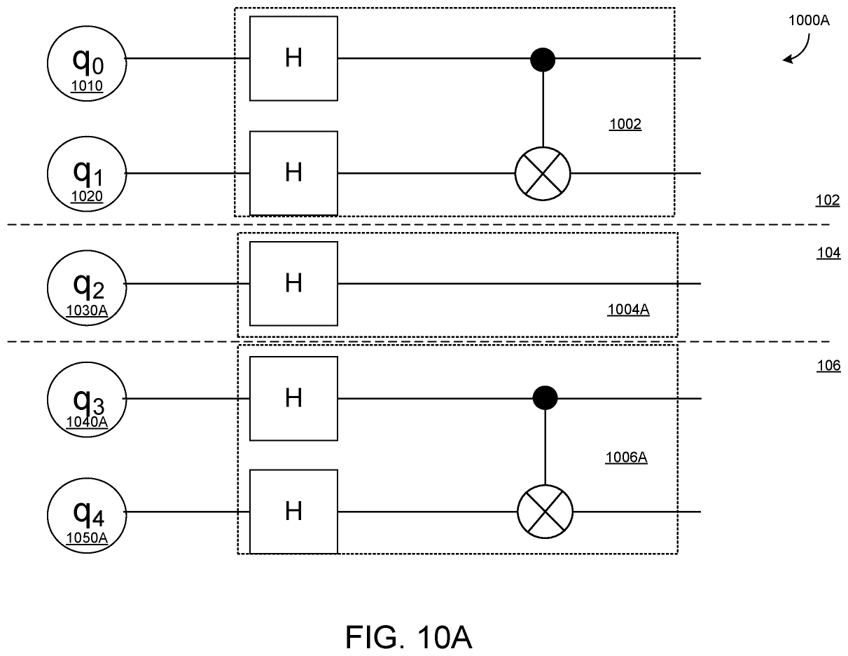

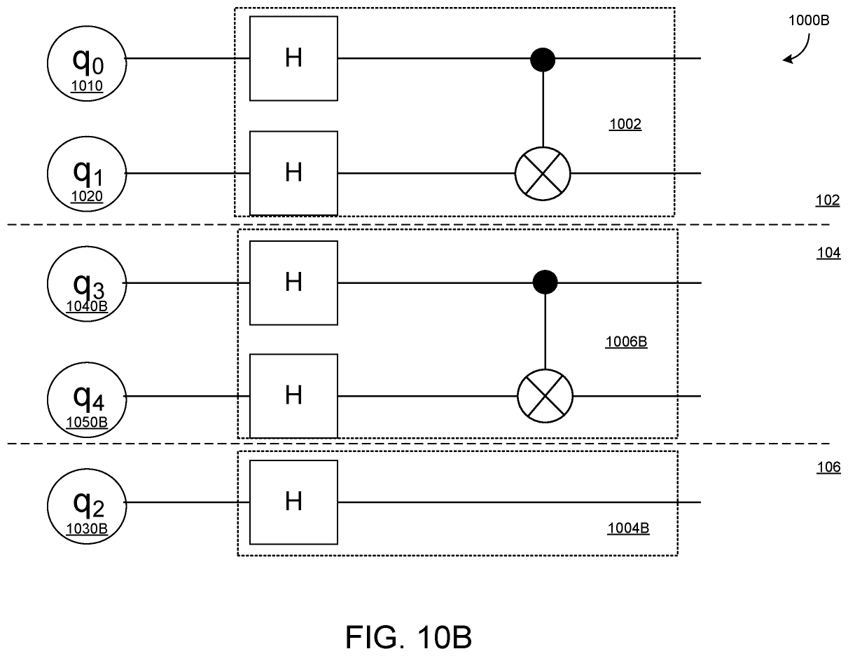

FIG. 10A depicts an example diagram of gate groups of a quantum circuit, in accordance with present implementations. FIG. 10A further depicts an example scenario in which a three-qubit gate group can be merged from gate groups of smaller qubit sizes. As illustrated by way of example in FIG. 10A, an example diagram of gate groups of a quantum circuit 1000A can include at least a first gate group at a first network level 1002, a second gate group at a second network level 1004A, and a third gate group at a third network level 1006A. This technical solution is not limited to the distribution or allocation of simulated quantum circuits at the particular device layers, gate layers, local layers, or global layers discussed herein by way of example.

The first gate group 1002 can correspond to a portion of a simulated quantum circuit at the device layer 102. The first gate group at a first network level 1002 can be coupled with a first qubit 1010, and a second qubit 1020, and can include two quantum gates and one controlled gate. The second gate group 1004A can correspond to a portion of a simulated quantum circuit at the lower network layer 104. The second gate group 1004A can be coupled with a third qubit 1030A and can be absent any quantum gates, and can thus have a complexity lower than a complexity of the first gate group 1002. The third gate group 1006A can correspond to a portion of a simulated quantum circuit at the higher network layer 106. The third gate group 1006A can be coupled with a fourth qubit 1040A, and a fifth qubit 1050A, and can include two quantum gates and one controlled gate, and can thus have a complexity matching a complexity of the first gate group 1002 and higher than a complexity of the second gate group 1004A.

FIG. 10B depicts an example diagram of sorted gate groups of a quantum circuit, in accordance with present implementations. As illustrated by way of example in FIG. 10B, an example diagram of sorted gate groups of a quantum circuit 1000B can include at least a second gate group sorted to a third network level 1004B, and a third gate group sorted to a second network level 1006B. The second gate group 1004B can be sorted to the lower network layer 104 in response to a determination that the complexity of the second gate group 1004A is greater than the complexity of the gate group 1006A. Correspondingly, the third gate group 1006B can be sorted to the higher network layer 106 in response to the determination that the complexity of the second gate group 1004A is greater than the complexity of the gate group 1006A.

As the created gate groups are applied sequentially to the state vector, qubits in a circuit are reordered between applications of gate groups. Each group has its own set of qubits, and by comparing the qubit sets of the two groups, the set of qubits changing allocation among devices can be determined. Reordering of the state vector elements can be done in place. For example, using source and destination buffers for this reordering can increase memory load, resulting in one less maximum qubit in the state vector. Therefore, qubit reordering can be defined by using swaps of qubit pairs. Swapping qubit pairs can be identical to swapping state vector elements that do not require extra buffers.

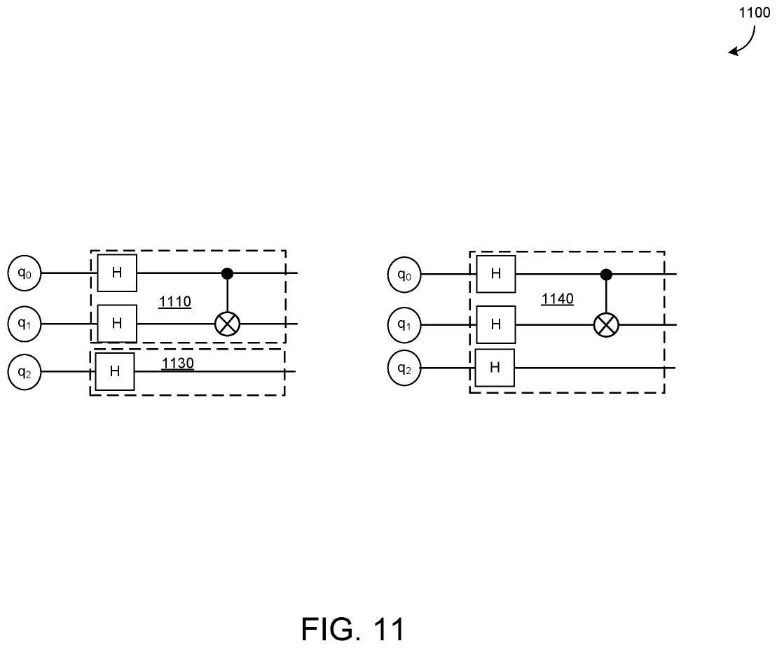

FIG. 11 depicts an example quantum circuit with gate groupings selected based on group size thresholds, in accordance with present implementations. FIG. 11 further depicts an example merging or fusing between gate groups in the scenario presented in FIGS. 10A and 10B. As illustrated by way of example in FIG. 11, an example quantum circuit with gate groupings based on group size thresholds 1100 can include at least a first gate group at a two-qubit threshold 1110, a second gate group under a two-qubit threshold 1130, and a first gate group at a three-qubit threshold 1140. The first gate group at a two-qubit threshold 1110 can include two quantum gates and one control gate, corresponding collectively to first and second qubits. The second gate group under a two-qubit threshold 1130 can include one quantum gate corresponding to a third qubit. The first gate group at a three-qubit threshold 1140 can include the three quantum gates and the one control gate, corresponding collectively to the first, second and third qubits.

FIG. 12 depicts an example quantum circuit simulation architecture, in accordance with present implementations. As illustrated by way of example in FIG. 12, an example quantum circuit simulation architecture 1200 can include at least a client device 1210, a quantum simulation computing platform 1220, a quantum state simulation engine 1230, and a simulation output 1260. The client device 1210 can include a physical computer system operatively coupled or that can be coupled with the quantum circuit simulation architecture 1200, either directly or directly through an intermediate computing device or system. The client device 1210 can include a mobile device, smartphone, tablet, phablet, desktop computer, or wearable device, but is not limited thereto.

The quantum simulation computing platform 1220 can include a physical computer system operatively coupled or that can be coupled with the client device 1210, either directly or directly through an intermediate computing device or system. The quantum simulation computing platform 1220 can include a virtual computing system, an operating system, and a communication bus to effect communication and processing. The quantum simulation computing platform 1220 can include a quantum state simulation engine 1230 and a simulation processing component(s) 1240.

The quantum state simulation engine 1230 can simulate various components of a simulated quantum circuit. For example, the quantum state simulation engine 1230 can simulate one or more quantum gates, store or maintain aspects of operation of various quantum gates, store or maintain a data structure corresponding to a structure of a quantum circuit, or any combination thereof. The quantum state simulation engine 1230 can include a computing platform topology profile 1232 and a state vector initialization engine 1234. The computing platform topology profile 1232 can identify a network topology configured to simulate a quantum circuit or portion thereof. For example, the computing platform topology profile 1232 can identify the architecture 100, can identify the devices and switches of the architecture 100, and can identify links between the devices and switches. For example, the computing platform topology profile 1232 can obtain or determine latency between various devices of the architecture 100, including particular latency associated with each link between each device.

The state vector initialization engine 1234 can generate a state vector corresponding to one or more simulated qubits, or a plurality of state vectors each corresponding to one or more distinct simulated qubits. The state vector initialization engine 1234 can generate the state vector or state vectors having a plurality of values, which include index bits that represent the wires of a quantum circuit using (e.g., binary) values. As discussed herein, “simulated” is not limited to a current or past tense of simulation, and is not limited to an initialized simulation. For example, “simulated” can correspond to an object that can be simulated. For example, the state vector initialization engine 1234 can divide or apportion a state vector into one or more portions, and can allocate the portions to one or more devices of the architecture 100.

The simulation processing component 1240 can modify at least a portion of a quantum circuit according to a quantum state vector. The simulation processing component 1240 can allocate portions of a quantum state vector across the architecture 100. The simulation processing component 1240 can include a reordered state vector allocation map 1242, and a quantum circuit simulator 1250. The reordered state vector allocation map 1242 can correspond to an identification of an allocation of one or more portions of a quantum state vectors to one or more devices of the architecture 110. For example, the reordered state vector allocation map 1242 can correspond to a transformation of a quantum state vector allocation map generated by the state vector initialization engine 1234 in response to a swap of portions of a state vector between devices.

The quantum circuit simulator 1250 can simulate quantum circuits according to quantum state vector. The simulation processing component 1240 can simulate the quantum circuit according to the portions of a quantum state vector distributed across the architecture 100 and allocated to one or more of the devices 110, 112, 114 or 116. The quantum circuit simulator 1250 can include a state vector allocation component 1252, and a quantum computing component 1254. The state vector allocation component 1252 can allocate one or more portions of a quantum state vector to one or more devices. The quantum computing component 1254 can simulate operation of one or more quantum computing components according to a simulated quantum circuit. For example, the quantum computing component 1254 can store models corresponding to one or more qubits, quantum gates, types of quantum gates, instances of qubits, instances of quantum gates, or any combination thereof. For example, models can correspond to logical, statistics, geometric, or physical models of the components discussed herein. The simulation output 1260 can correspond to a measurement result of the simulated quantum state of the simulated quantum circuit. The measurement result can correspond to a simulated collapse of one or more quantum states according to one or more quantum state vectors, and a solution to the simulation quantum circuit.

FIG. 13 depicts an example quantum state vector allocation architecture, in accordance with present implementations. As illustrated by way of example in FIG. 13, an example quantum state vector allocation architecture 1300 can include at least an initialized state vector allocation map 1310, a gate grouping engine 1320, and a state vector allocation engine 1330.

The initialized state vector allocation map 1310 can indicate a correspondence between one or more portions of a state vector or portion of a state vector and one or more devices on which the state vector or portions of state vector are executed. For example, the initialized state vector allocation map 1310 can correspond at least partially in one or more of structure and operation to a state vector generated by the state vector initialization engine 1234, according to an initialization of a simulated quantum circuit.

The gate grouping engine 1320 can generate one or more gate groups of the simulated quantum circuit according to gate groups as discussed herein. The gate grouping engine 1320 can include a gate sort engine 1322, and a gate merge engine 1324. The gate sort engine 1322 can sort gate group according to complexity to identify gate groups to be allocated to lower layers of a network architecture. The gate merge engine 1324 can identify portions of a simulated quantum circuit corresponding to particular qubits, according to connections between gates of the gate group and various qubits. For example, the gate merge engine 1324 can complete one or more gate groups or identify one or more portions of a state vector corresponding to qubits of a gate group.

The state vector allocation engine 1330 can transmit a state vector or a portion of a state vector, or any plurality thereof, to one or more devices of a network architecture configured to simulate a quantum circuit. The state vector allocation engine 1330 can include a local bit swap processor 1332, and a global bit swap processor 1334. The local bit swap processor 1332 can allocate portions of a state vector representing a simulated qubit based on one or more of global swap bits or local swap bits. The global bit swap processor 1334 can allocate a state vector or portions of the state vector to swap based on one or more of global swap bits or local swap bits according to a global bit swap operation 610.

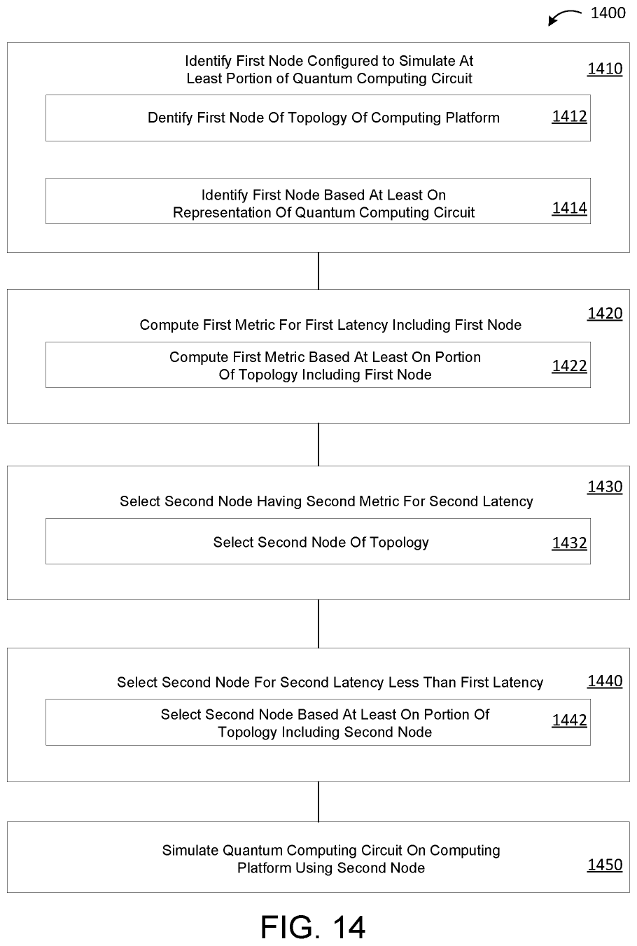

FIG. 14 depicts an example method of allocation of quantum state vector components across network devices in quantum computing simulation, in accordance with present implementations. At least one of the architectures 100, 200, 1200 and 1300 can perform method 1400.

At 1410, the method 1400 can identify a first node (e.g., processing device) configured to simulate at least a first portion of a state vector representing a quantum computing circuit. For example, the method can include selecting a first subset or portion of the state vector corresponding to a first qubit of the quantum computing circuit. The method can include identifying one or more first quantum gates of the quantum computing circuit coupled with the first qubit and measurable with input restricted to the first qubit. The method can include selecting, based at least on a gate group that includes the first qubit and the first quantum gates, a second node (e.g., device) to simulate a second subset or portion. For example, the processor can select a first subset or portion of the quantum computing circuit corresponding to a first qubit of the quantum computing circuit. The processor can identify one or more first quantum gates of the quantum computing circuit coupled with the first qubit and measurable with input restricted to the first qubit. The processor can select, based at least on a gate group that can include the first qubit and the first quantum gates, the second node to simulate one or more second sets of quantum gates of the quantum computing circuit. At 1412, the method 1400 can identify a first processing node of a network topology of a computing platform. For example, the topology comprises a profile of computing resources of the computing platform for executing a simulation of the quantum computing circuit. At 1414, the method 1400 can identify a first node based at least on a representation of a quantum computing circuit. For example, the method can include selecting, in response to a determination that the first subset or portion can include a quantum gate dependent on input based at least on a second qubit of the quantum computing circuit, a second subset or portion of the quantum computing circuit corresponding to the second qubit. For example, the processor can select, in response to a determination that the first subset or portion can include a quantum gate dependent on input based at least on a second qubit of the quantum computing circuit, a second subset or portion of the quantum computing circuit corresponding to the second qubit.

At 1420, the method 1400 can compute a first value for a latency metric indicative of a first latency including the first node. At 1422, the method 1400 can compute a second value for the latency metric based at least on a portion of the topology including the second node.

At 1430, the method 1400 can select a second node having a second value for the latency metric for a second latency. At 1432, the method 1400 can select a second node of the topology to reorder (swap) the distribution of operations corresponding to the second qubit based on the determination that the operations corresponding to the first qubit and represented by the first subset or portion of the state vector are dependent upon the completion of the operations corresponding to the second qubit. The method can include selecting the second node based at least on a gate group can include the first qubit, the second qubit, the first quantum gates, and the second quantum gates. For example, the processor can identify one or more second quantum gates of the quantum computing circuit coupled with the first qubit and measurable with input restricted to the first qubit and a second qubit of the quantum computing circuit. The processor can select the second node based at least on a gate group can include the first qubit, the second qubit, the first quantum gates, and the second quantum gates.

At 1440, the method 1400 can select a second node for a second latency less than the first latency. At 1442, the method 1400 can select a second node based at least on a portion of the topology including the second node. For example, the method can include allocating, to the second node, at least a portion of a state vector corresponding to the portion of the quantum computing circuit. The method can include deallocating, from the first node, at least the portion of the state vector.

For example, the method can include generating one or more gate groups each can include one or more qubits of the quantum computing circuit, each of the gate groups satisfying a threshold indicating a maximum number of local index bits that can be allocated to a gate group among the gate groups. The method can include combining, in response to a determination that a first gate group among the gate groups and a second gate group among the gate groups include a number of the qubits satisfying the threshold, the first gate group and the second gate group. For example, the method can include sorting, into a group order based on corresponding numbers of qubits in each of the gate groups, each of the gate groups. The method can include determining, in response to iteration over one or more of the gate groups according to the group order, that the first gate group and the second gate group include the number of the qubits satisfying the threshold.

For example, the processor can generate one or more gate groups each can include one or more qubits of the quantum computing circuit, each of the gate groups satisfying a threshold indicating a maximum number of qubits that can be allocated to a gate group among the gate groups. The processor can combine, in response to a determination that a first gate group among the gate groups and a second gate group among the gate groups include a number of the qubits satisfying the threshold, the first gate group and the second gate group. For example, the processor can sort, into a group order based on corresponding numbers of qubits in each of the gate groups, each of the gate groups. The processor can determine, in response to iteration over one or more of the gate groups according to the group order, that the first gate group and the second gate group include the number of the qubits satisfying the threshold.

At 1450, the method 1400 can simulate the quantum computing circuit on the computing platform using the second node. For example, the processor can allocate, to the second node, at least a portion of a state vector corresponding to the portion of the quantum computing circuit. The processor can reallocate (redistribute), from the first node, at least the portion of the state vector. For example, the method can include outputting a simulation result for the quantum computing circuit, where the simulation result is computed based at least on simulation results of simulating the quantum computing circuit on the computing platform using the second node. For example, the processor can output a simulation result for the quantum computing circuit, where the simulation result is computed based at least on simulation results of simulating the quantum computing circuit on the computing platform using the second node.

For example, the processor is comprised in a control system for an autonomous or semi-autonomous machine. For example, the processor is comprised in a perception system for an autonomous or semi-autonomous machine. For example, the processor is comprised in a system for performing simulation operations. For example, the processor is comprised in a system for performing digital twin operations. For example, the processor is comprised in a system for performing light transport simulation. For example, the processor is comprised in a system for performing collaborative content creation for 3D assets. For example, the processor is comprised in a system for generating or presenting at least one of virtual reality content, augmented reality content, or mixed reality content. For example, the processor is comprised in a system for performing deep learning operations. For example, the processor is comprised in a system implemented using an edge device. For example, the processor is comprised in a system implemented using a robot. For example, the processor is comprised in a system for performing conversational AI operations. For example, the processor is comprised in a system for generating synthetic data. For example, the processor is comprised in a system incorporating one or more virtual machines (VMs). For example, the processor is comprised in a system implemented at least partially in a data center. For example, the processor is comprised in a system for performing generative AI operations. For example, the processor is comprised in a system implemented at least partially using a language model. For example, the processor is comprised in a system implemented at least partially using cloud computing resources. For example, the processor is comprised in a system implemented at least partially using quantum computing resources. For example, the processor is comprised in a system utilizing a Quantum Processing Unit (QPU). For example, the processor is comprised in a system for performing a state preparation. For example, the processor is comprised in a system for compiling a quantum circuit, a system for executing a quantum circuit. For example, the processor is comprised in a system for measuring a quantum state. The system can or a system for measuring a state of a qubit or qubits.

For example, the method is executable by a control system for an autonomous or semi-autonomous machine. For example, the method is executable by a perception system for an autonomous or semi-autonomous machine. For example, the method is executable by a system for performing simulation operations. For example, the method is executable by a system for performing digital twin operations. For example, the method is executable by a system for performing light transport simulation. For example, the method is executable by a system for performing collaborative content creation for 3D assets. For example, the method is executable by a system for generating or presenting at least one of virtual reality content, augmented reality content, or mixed reality content. For example, the method is executable by a system for performing deep learning operations. For example, the method is executable by a system implemented using an edge device. For example, the method is executable by a system implemented using a robot. For example, the method is executable by a system for performing conversational AI operations. For example, the method is executable by a system for generating synthetic data. For example, the method is executable by a system incorporating one or more virtual machines (VMs). For example, the method is executable by a system implemented at least partially in a data center. For example, the method is executable by a system for performing generative AI operations. For example, the method is executable by a system implemented at least partially using a language model. For example, the method is executable by a system implemented at least partially using cloud computing resources. For example, the method is executable by a system implemented at least partially using quantum computing resources. For example, the method is executable by a system utilizing a Quantum Processing Unit (QPU). For example, the method is executable by a system for performing a state preparation. For example, the method is executable by a system for compiling a quantum circuit. For example, the method is executable by a system for executing a quantum circuit. For example, the method is executable by a system for measuring a quantum state. For example, the method is executable by or a system for measuring a state of a qubit or qubits.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items. References to “is” or “are” may be construed as nonlimiting to the implementation or action referenced in connection with those terms. The terms “is” or “are” or any tense or derivative thereof are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Scope of the systems and methods described herein is thus indicated by the appended claims, rather than the foregoing description. The scope of the claims includes equivalents to the meaning and scope of the appended claims.

What is claimed is:

1. A processor comprising:
one or more circuits to:
identify, based at least on a representation of a quantum computing circuit, a first distribution corresponding to an allocation of one or more portions of the quantum computing circuit for simulation using a plurality of processing devices of a computing platform arranged according to a network topology;
compute a first latency value according to a latency metric, the first latency value indicating a latency corresponding to simulating operations associated with the one or more portions of the quantum computing circuit according to the first distribution;
determine, based on the network topology, a second distribution corresponding to a reallocation of at least one operation associated with the one or more portions of the quantum computing circuit based at least on a hierarchy of the network topology;
compute a second latency value that is less than the first latency according to the latency metric, the second latency value indicating a latency corresponding to simulating the one or more portions of the quantum computing circuit according to the second distribution; and
simulate the quantum computing circuit on the computing platform using the second distribution.

2. The processor of claim 1, wherein the one or more circuits are to:
redistribute, to the at least one different processing node, at least a portion of a state vector corresponding to the portion of the quantum computing circuit to simulate.

3. The processor of claim 1, wherein to determine the second distribution, the one or more circuits are to:
select a first portion of the quantum computing circuit corresponding to a first qubit of the quantum computing circuit, the first qubit being allocated to a first processing device of the computing platform according to the first distribution;
identify a gate group associated with the first qubit, the gate group comprising the first qubit and one or more first quantum gates of the quantum computing circuit coupled with the first qubit and measurable with input restricted to the first qubit; and
select, based at least on the gate group, the first qubit to be reallocated for simulation using a second processing device of the computing platform, the second processing device comprising a different processing device from the first processing device.

4. The processor of claim 3, wherein the one or more circuits are to:
identify a third processing device of the computing platform allocated to simulate at least one operation of the gate group associated with the first qubit.

5. The processor of claim 3, wherein the second processing device comprises a processing device corresponding to a same layer of the hierarchy of the network layer as the third processing device.

6. The processor of claim 1, wherein the one or more circuits are to:
generate two or more gate groups each including one or more qubits of the quantum computing circuit, each of the gate groups satisfying a threshold indicating a maximum number of qubits that can be allocated to a gate group among the gate groups; and
combine a first gate group of the two or more gate groups and a second gate group of the two or more gate groups in response to a determination that the first gate group and the second gate group include a number of the qubits satisfying the threshold.

7. The processor of claim 6, wherein the one or more circuits are to:
sort the two or more gate groups into a group order based on corresponding numbers of qubits in each of the gate groups; and
determine, in response to iteration over one or more of the gate groups according to the group order, that the first gate group and the second gate group include the number of the qubits satisfying the threshold.

8. The processor of claim 1, wherein the one or more circuits are to:
output a simulation result for the quantum computing circuit, wherein the simulation result is computed based at least on simulation results of simulating the quantum computing circuit on the computing platform according to the second distribution.

9. The processor of claim 1, wherein the network topology comprises a hierarchical profile of computing resources of the computing platform for executing a simulation of the quantum computing circuit.

10. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device; a system implemented using a robot;
a system for performing conversational AI operations;
a system for generating synthetic data;
a system incorporating one or more virtual machines (VMs);
a system implemented at least partially in a data center;
a system for performing generative AI operations;
a system implemented at least partially using a language model;
a system implemented at least partially using cloud computing resources;
a system implemented at least partially using quantum computing resources;
a system utilizing a Quantum Processing Unit (QPU);
a system for performing a state preparation; a system for compiling a quantum circuit;
a system for executing a quantum circuit; a system for measuring a quantum state; or
a system for measuring a state of a qubit or qubits.

11. A method comprising:
identifying, based at least on a representation of a quantum computing circuit, a first distribution corresponding to an allocation of one or more portions of the quantum computing circuit for simulation using a plurality of processing devices of a computing platform arranged according to a network topology;
computing a first latency value according to a latency metric, the first latency value indicating a latency corresponding to simulating operations associated with the one or more portions of the quantum computing circuit according to the first distribution;
determining, based on the network topology, a second distribution corresponding to a reallocation of at least one operation associated with the one or more portions of the quantum computing circuit based at least on a hierarchy of the network topology;
computing a second latency value that is less than the first latency according to the latency metric, the second latency value indicating a latency corresponding to simulating the one or more portions of the quantum computing circuit according to the second distribution; and
simulating the quantum computing circuit on the computing platform using the second distribution.

12. The method of claim 11, further comprising:
redistributing, to the at least one different processing node, at least a portion of a state vector corresponding to the portion of the quantum computing circuit to simulate.

13. The method of claim 11, the determining the second distribution comprises:
selecting a first portion of the quantum computing circuit corresponding to a first qubit of the quantum computing circuit, the first qubit being allocated to a first processing device of the computing platform according to the first distribution;
identifying a gate group associated with the first qubit, the gate group comprising the first qubit and one or more first quantum gates of the quantum computing circuit coupled with the first qubit and measurable with input restricted to the first qubit; and
selecting, based at least on the gate group, the first qubit to be reallocated for simulation using a second processing device of the computing platform, the second processing device comprising a different processing device from the first processing device.

14. The method of claim 13, further comprising identifying a third processing device of the computing platform allocated to simulate at least one operation of the gate group associated with the first qubit.

15. The method of claim 13, wherein the second processing device comprises a processing device corresponding to a same layer of the hierarchy of the network layer as the third processing device.

16. The method of claim 11, further comprising:
generating two or more gate groups each including one or more qubits of the quantum computing circuit, each of the gate groups satisfying a threshold indicating a maximum number of qubits that can be allocated to a gate group among the gate groups; and
combining a first gate group of the two or more gate groups and a second gate group of the two or more gate groups in response to a determination that the first gate group and the second gate group include a number of the qubits satisfying the threshold.

17. The method of claim 16, further comprising:
sorting the two or more gate groups into a group order based on corresponding numbers of qubits in each of the gate groups; and
determining, in response to iteration over one or more of the gate groups according to the group order, that the first gate group and the second gate group include the number of the qubits satisfying the threshold.

18. The method of claim 11, further comprising:
outputting a simulation result for the quantum computing circuit, wherein the simulation result is computed based at least on simulation results of simulating the quantum computing circuit on the computing platform according to the second distribution.

19. The method of claim 11, wherein the network topology comprises a hierarchical profile of computing resources of the computing platform for executing a simulation of the quantum computing circuit.

20. A system comprising:
a computing platform comprising a plurality of processing devices arranged according to a hierarchical network topology, wherein a quantum computing circuit is simulated as a plurality of portions of the quantum computing circuit using the plurality of processing devices by redistributing, based at least on a hierarchy of the network topology, at least one operation corresponding to a portion of the plurality of portions from a first processing device of the plurality of processing devices to a second processing device of the plurality of processing devices to reduce a communication latency corresponding to a simulation of the quantum computing circuit.
